(19) United States
(12) Patent Application Publication
(10) Pub. No.: US 2004/0255898 A1
(43) Pub. Date: Dec. 23, 2004

(54) Tri-vane rotary engine

(76) Inventor: Rodolfo C. Demafiles, Iloilo (PH)

Correspondence Address: Rodolfo C. Demafiles, c/o Noel S. Demafiles, 9088 Manalang Road, Las Vegas, NV, 89123, US

(21) Appl. No.: 10/465,246

(22) Filed: Jun. 19, 2003

(51) Int. Cl. F02B 53/04

(52) U.S. Cl. 123/237

(57) ABSTRACT

A rotary internal combustion engine with variable and transferable volume working chambers constituted by partly depressed stationary peripheral close curve casing with parallel end wall casings housing a revolving cylindrical rotor containing three rectangular sliding drive vanes, said rotor fastened to an engine shaft and revolving about a concentric axis, said engine performing simultaneous fuel intake, compression, expansion and exhaust during operation producing direct rotational power.

### BACKGROUND OF THE INVENTION

1. Field of the Invention

The present invention relates in general to rotary internal combustion engine and in particular to rotary internal combustion engine with variable and transferable working chambers constituted by stationary enclosure housing a cylindrical rotor with rectangular sliding drive vanes, fastened to an engine shaft and revolving about a concentric axis producing direct rotational power.

2. Description of Prior Arts

Design of rotary internal combustion engine that duplicates power-producing functions of reciprocating engine by rotary motion had been long desired even before the advent and development of efficient reciprocating piston engine. Ideal condition of fuel mixture under elevated pressure just before combustion and sealing of working chambers are two major and intriguing problems associated with design of rotary engine.

According to available records, as early as 1558 designs for rotary engine had been proposed and considered. Before 1910, more than 2,000 patents for rotary pistons were filed.² Among the rotary engines proposed, the following previous designs are referred to as relevant references in order to examine their feature and characteristics and understand better the problems behind what this present invention come to solve. 2 History of Rotary Machines. USPTO Mail and other Emergency Related Info website.

Generally, rotary engine can be classified under four categories, namely; a) Cat-and-Mouse engine where the rotor travel in a start and stop movement around a toroidal cylinder, b) multiple-rotor engine where two or more rotors revolved in a simple rotary motion, c) eccentric rotor engines where motion is imparted to a shaft by a principal rotating part or rotor that is eccentric to the shaft, and d) revolving-block engine which combine reciprocating piston motion with rotational motion of the entire engine block.³ ³ Classification and description of the engines are taken mainly from Mc-Graw-Hill Encyclopedia of Science and Technology 6^{th} ed. pages 551 to 557, with some insertion and omission supplied by the inventor.

Cat-and-mouse engines: A rotary engine, has a cat-and mouse characteristic where the four stages of fuel intake, compression, expansion, and exhaust are accomplished by actions of two pairs of pistons that travel around a toroidal cylinder. In this type of engine the intermittent starting and stopping of revolving rotor and pistons cause transfer and compression of fuel mixture. However, at high speeds the sudden stopping and starting of rotor and pistons can result to considerable engine vibration aside from subjecting the moving parts under tremendous high stress.

Another engine with cat-and-mouse characteristics is the type in which the pistons are vanes that are sections of a right circular cylinder. One set of pistons is attached to one rotor so that these two pistons rotate with a constant angular velocity. The motion of the second set of pistons is controlled by a complex gear-and-crank arrangement so that the angular velocity of the second set varies. In this manner, the chambers between the pistons can be made to vary in volume in a prescribed manner. Hence, the standard piston-engine cycle can be duplicated. Here again, however, the varying angular velocity of the second set of pistons must produce inertia effects that will be absorbed by the gear-and-crank system. At high speed over extended periods, problems with this system are likely to be encountered.

Multi-Rotor engine—A typical design of this type of rotary engine is similar to pump or compressor where fuel-air mixture enters the combustion chamber through some type of valve. No compression takes place, rather a spark plug ignites the mixture which burns in the combustion chamber with a consequent increase in temperature and pressure. The hot gas expands by pushing against the two trochoidal rotors. The eccentric force on one rotor forces the rotors to rotate. Eventually, the combustion gases find their way out of the exhaust.

Another multi-rotor rotary engine is a type with two circular rotors, one of which has a single gear tooth upon which the gas pressure acts. The second rotor has a slot that accepts the gear tooth. The two rotors are in constant frictional contact which can lead to increase temperature and wear of rotors. The absence of compression phase and sealing problems between rotors associated with this type of rotary engine can lead to low efficiency and difficulties in the engine.

Eccentric-rotor engine—An eccentric rotary engine has its “rotor move in one direction around the trochoidal chamber that contains peripheral intake and exhaust ports. The rotor is triangular in shape and divides the housing into three chambers with each chamber the analog of the cylinder in the standard piston engine. Fuel intake, compression, expansion, and exhaust are performed simultaneously during eccentric movements of the rotor around the shaft by means of cycloidal gearing.” The use of gears and eccentric movements of the rotor make this engine intricate. “During the combustion-expansion phase unburned gas tends to flow at the opposite corner. As a result this engine has a tendency to leave a portion of the charge unburned thus reducing the engine performance.”

Revolving-block engines—This type of engine combine reciprocating piston with rotational motion of the entire engine block. In this engine, however, some fresh charge is lost to the exhaust during the transfer process. Stresses on the roller assembly and cylinder walls are likely to be high. Cooling is also a problem since cooling of the pistons is difficult to achieve.

References Cited⁴ ⁴ From http:/patft.uspto.gov/netacgi/nph-Parser?Sect1=PTO2&Sect2=H1TOFF&p=1&u/netahtml.

A rotary internal combustion engine with U.S. Pat No. 3,855,977 constituted by an outer cylindrical casing with interior periphery and end plates and cooperatively housing a rotor which revolves about an axis thru the end plate walls. The rotor is pivotally mounted with multiple pistons which radially oscillate by means of trunnion pin which follow the contour of cam groove on the interior face of end plate walls. Each piston is provided with a recess or cavity at its periphery which accommodate air-fuel mixture and compresses said air-fuel mixture when said piston reaches “compression” position during rotation of the rotor. The four stages of intake, compression, expansion, and exhaust of fuel mixture are accomplished during 180 degrees rotation of the rotor resulting in two power stages per complete revolution of engine shaft.

A rotary internal combustion engine with U.S. Pat No. 1,849,398, is constituted by a peripheral circular casing with pockets at 180 degrees opposite positions and form the combustion chambers in cooperation with “impact members, each of which includes a compression member movable in relation to the impact member by a generally oval shape cam. The impact member and compression member are pivotally mounted adjacent to the outer periphery of a rotor adopted to be rotated within the inner periphery of the casing.”

A rotary internal combustion engine with U.S. Pat. No. 1,222,475 is constituted by a cylindrical outer peripheral casing housing a rotor fastened to a drive shaft. Both rotor and shaft revolves about a concentric axis. The outer surface of the rotor in cooperation with peripheral casing and pivotally journaled piston blade form the combustion chamber during rotation involving intake, compression, power and exhaust operation.

A rotary piston machine with U.S. Pat No. 4,561,836, in order to avoid losses due to compressed flows, has adjacent to a generating and/or sealing contact edge at least one recess and/or opening which extends beyond the contact curve in at least approximately the direction of motion of the surfaces moving in relation to each other during the stroke or passage of the piston thru the shut-off drives. The spatial dimensions of the recesses and/or opening are such that the flow in it is not substantially accelerated even when the direction is changed. An opening can be closed insofar as it is located in a non-moving ring. To prevent low pressures between surfaces moving away from each other a pressure compensation space is connected to the contact line of one of the surfaces.”

A rotary engine with U.S. Pat No. 6,289,867 with a central chamber formed by peripheral housing and a pair of nested rotors enclosed in said peripheral housing with four variable volume sub-chambers. The rotors are fastened to an engine shaft and rotate about thru axial bore of the housing assembly. The engine utilizes tunable gas compression and expansions in order to control emissions without necessity of exhaust gas recirculation or use of complicated fuel injection system.

A rotary engine with U.S Pat No. 4,072,132 is an “internal combustion engine that utilizes auto-ignition of fuel and water injection into the combustion chamber for greater efficiency and reduction of pollutants.” The engine consist of a peripheral cylindrical casing and end plate walls which cooperatively constitute the stationary housing. The end plate walls are provided with cam grooves and central bores through which a shaft with appropriate bearings passes thru and rotate with rotor plates which are fastened or keyed to the shaft. “Mounted or formed integrally between the rotor plates, each of which is spaced just inside one of the end plates of the housing, with appropriately sealing means there-between, are a plurality of separator members each of which is provided with an air passage to receive air blown into the housing, preferably through the central shaft. Also mounted on and between the rotor plates and between adjacent separator members are a plurality of segments in the nature of “pistons” each having an arm provided with a bearing that operates in the cam groove of each associated end plate. Each of the segments or “pistons” is also pivoted by appropriate trunnions to the rotor plates so that as the rotor plates rotate, carrying the segments therewith, the relationship of the outer surface or periphery of each of the segments with the inner periphery of the cylindrical casing varies as the segments proceed around the axis of the shaft. The relationship between the outer peripheral surface of each segment and the inner peripheral surface of the housing varies between formation of a combustion chamber in which the outer periphery of each segment is sealingly associated with the inner periphery of the housing to contain a full-air-charge to a retracted position in which air is blown through the separator member and scavenges the products of combustion from the space between the traveling segment and the interior surface of the rotor end plates. At appropriate intervals in the cycle, fuel is injected into the combustion chamber and water is injected into a cavity formed adjacent the trailing end of the segment. Appropriate sealing means are provided on associated sides of each segment to contain the products of combustion in selected areas. “Means for injecting water and fuel mixture into the combustion area are also provided.”

The rotary engines cited above show various designs with varied features and characteristics. Some present complicated if not impractical methods of compressing fuel mixture prior to combustion; others lack or do not provide the means at all. While tremendous efforts had been exerted to attain greater efficiency, sealing against leakages still remain a continuing problem.

On the other hand the present invention introduces a simple and practical way of solving the problem by means of innovative design of working chambers and providing appropriate sealing means described herein below.

### SUMMARY OF THE INVENTION

The present invention is a rotary internal combustion engine with variable and transferable volume working chambers constituted by partly depressed stationary peripheral close curve casing with end walls housing a revolving cylindrical rotor containing rectangular sliding drive naves. The rotor is fastened to an engine shaft and rotates about a concentric axis producing direct rotational power of the engine shaft.

The principal object of the present invention is to design a rotary internal combustion engine with a simple process of compressing fuel mixture by means of innovative design of working chambers particularly the compression chamber with adequate and reliable sealing means.

Another object of the present invention is to design a rotary internal combustion engine with cylindrical rotor containing rectangular sliding drive vanes that radially move in and out of rotor slots by means of cam plates and peripheral casing and revolving about a concentric axis producing direct rotational power of the engine shaft.

It is also the object of the present invention to design a rotary internal combustion engine with relatively least number of simple parts.

### BRIEF DESCRIPTION OF THE DRAWINGS

The drawings herein shows the general shape and configuration of the engine with its major parts but do not provide detailed dimensions for fabrication or construction purposes. Also, the drawings submitted in Disclosure Document No. 497348 are herein revised for improved presentation. In FIG. 5a to 5f, the spokes of the rotor are purposely not drawn to simplify illustration of engine operation.

FIG. 1 is a view of the engine facing end 3 with wall casing 6 removed to show the major parts with designated numbers and letters in accordance with the present invention.

FIG. 2 is a longitudinal section of the engine through 2-2 in accordance with FIG. 1 showing the major parts including wall casings with designated numbers and letters.

FIG. 3 is a cross-section of the engine without the engine shaft thru 3-3 in accordance with the present invention.

FIG. 4 is unhatched identical section as in FIG. 2 showing elements and other parts not designated in previous Figures.

FIG. 5 is a series of reduced identical view as in FIG. 1 showing progressive rotation of rotor during engine operation.

FIG. 5a is a view showing vane 19 just past the intake port at the start of engine operation.

FIG. 5b is an identical view as in FIG. 5a with the rotor rotated to show initial entry of the fuel mixture into the intake chamber.

FIG. 5c is identical to FIG. 5b with the rotor further rotated to show the initial batch of fuel mixture trapped in the intake chamber.

FIG. 5d is identical to FIG. 5c with the rotor further rotated to show transfer of initial batch of fuel mixture from intake chamber to compression chamber and entry of second batch of fuel mixture.

FIG. 5e is identical to FIG. 5d with the rotor further rotated to show compression to ideal state (pressure) and combustion of initial batch of fuel mixture, trapping of second batch of fuel mixture in the intake chamber, and start of entry of third batch of fuel mixture.

FIG. 5f is identical to FIG. 5e with the rotor further rotated to show expansion of first batch of fuel mixture at the expansion (power) chamber and subsequent discharge of the same when vane 19 reaches and passes the exhaust port, transfer of second batch of fuel mixture to compression chamber, and further entry of third batch of fuel mixture.

FIG. 6 is an exploded isometric view of the engine showing the individual major parts and portion of part with designated numbers and letters.

FIG. 6i is typical isometric view of vanes 19,20 and 21 showing cut-out corners of end and inner edges.

FIG. 6j is an enlarged typical end view of vanes 19,20 and 21 showing connection of end and outer edge sealing elements.

FIG. 6k is an enlarged typical view of outer edge of vanes 19, 20 and 21 showing connections of sealing elements with pressures springs.

FIG. 6l is typical section thru x-x of FIG. 6k.

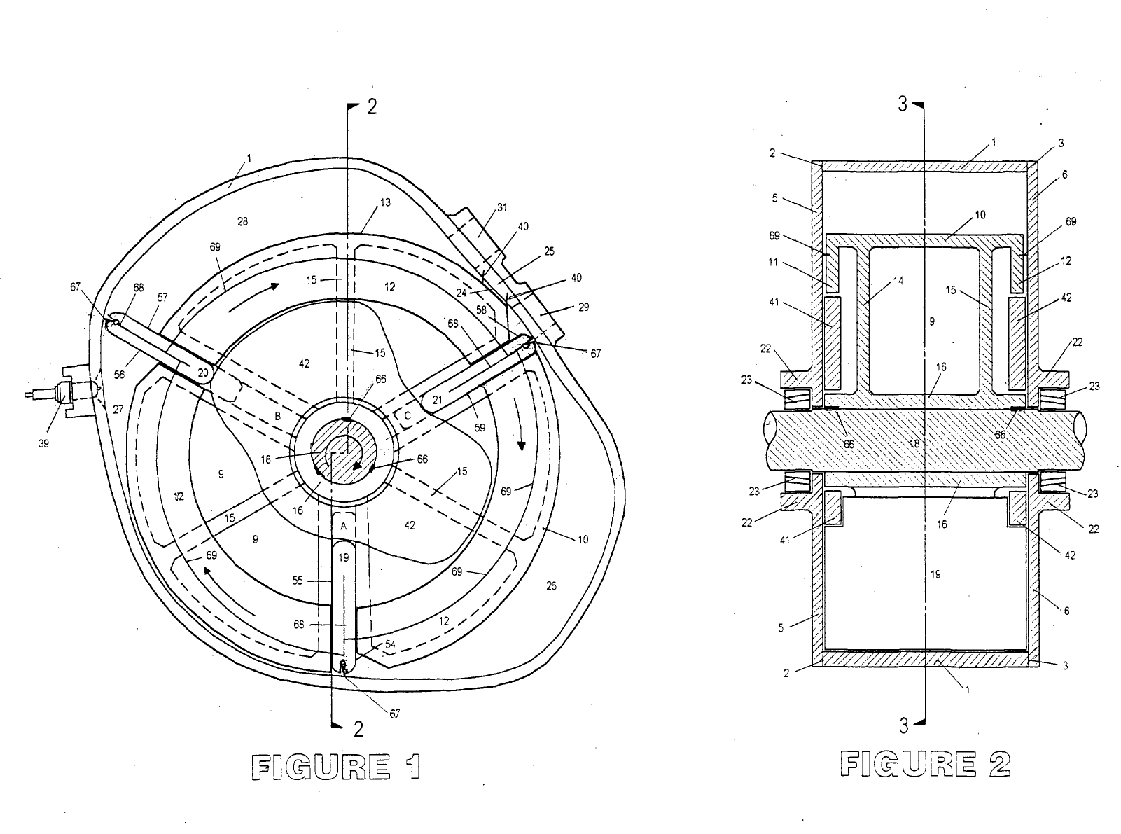

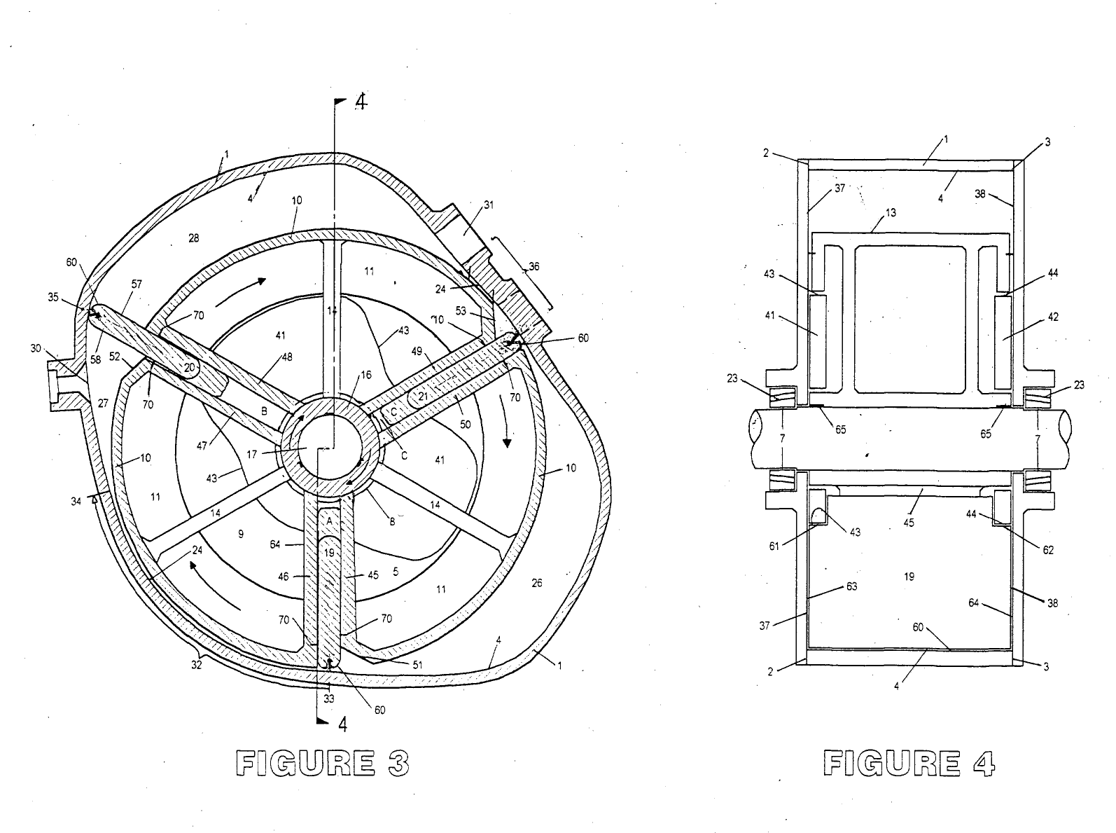

### LIST OF PARTS WITH DESIGNATED NUMBERS AND LETTERS AND SHOWN IN FIG. 1 TO FIG. 6

| Designated | |
|---|---|
| Numbers/Letters | Parts |
| 1 | Peripheral casing of stationary enclosure |
| 2 | End of peripheral casing 1 where wall casing 5 is fastened |
| 3 | End of peripheral casing 1 where wall casing 6 is fastened |
| 4 | Inner surface of peripheral casing 1 |
| 5 | Wall casing of stationary enclosure fastened to end 2 of peripheral |
| | casing 1 |
| 6 | Wall casing of stationary enclosure fastened to end 3 of peripheral |
| | casing 1 |
| 7 | Central axial bore of end wall casing 5 and 6 |
| 8 | Central axial bore of cam plates 43 and 44 |
| 9 | Rotor consisting of cylindrical rim with hollow disc-like end walls, |
| | hubs, radial slots, and rectangular sliding drive vanes |
| A | Radial slot of rotor 9 housing vane 19 |
| B | Radial slot of rotor 9 housing vane 20 |
| C | Radial slot of rotor 9 housing vane 21 |
| 10 | Cylindrical rim of rotor 9 |
| 11 | Hollow disc-like end wall of cylindrical rim 10 of rotor 9 facing end |
| | wall casing 5 |
| 12 | Hollow disc-like end wall of cylindrical rim 10 of rotor 9 facing end |
| | wall casing 6 |
| 13 | Outer surface of cylindrical rim 10 of rotor 9 |
| 14 | Set of spokes connecting cylindrical rim 10 to hub 16 of rotor 9 facing |
| | wall casing 5 |
| 15 | Set of spokes of rotor 9 facing wall casing 6 |
| 16 | Hub of rotor 9 |
| 17 | Shaft bore of hub 16 of rotor 9 |
| 18 | Engine shaft |
| 19 | Rectangular sliding drive vane of rotor 9 in radial slot A |
| 20 | Rectangular sliding drive vane of rotor 9 at radial slot B |
| 21 | Rectangular sliding drive vane of rotor 9 at radial slot C |
| 22 | Housing of shaft bearing on end wall casings 5 and 6 |
| 23 | Shaft bearings on end wall casings 5 and 6 |
| 24 | Clearance between outer surface 13 of cylindrical rim of rotor 9 and |
| | inner surface 4 of peripheral casing 1 at compression chamber 27 and |
| | at separator 25 |
| 25 | Separator that separate exhaust chamber 28 from intake chamber 26 |
| 26 | Intake chamber |
| 27 | Compression/combustion chamber |
| 28 | Expansion (power)/exhaust chamber |
| 29 | Intake port |
| 30 | Ignition hole and holder |
| 31 | Exhaust port |
| 32 | Depressed portion of peripheral casing 1 close (near) to outer surface |
| | 13 of cylindrical rim 10 of rotor 9 at compression/combustion |
| | chamber 27 |
| 33 | Point of beginning of compression/combustion chamber 27 |
| 34 | Point of end of depressed portion of peripheral casing 1 close (near) |
| | to outer surface 13 of cylindrical rim 10 of rotor 9 at compression/ |
| | combustion chamber |
| 35 | Point of end of compression/combustion chamber 27 |
| 36 | Depressed portion of peripheral casing 1 close (near) to outer surface |
| | 13 of cylindrical rim 10 of rotor 9 at separator 25 |
| 37 | Inner surface of wall casing 5 |
| 38 | Inner surface of wall casing 6 |
| 39 | Ignition element |
| 40 | Sealing element at separator 25 |
| 41 | Cam plate fastened to wall casing 5 |
| 40 | Sealing element at separator 25 |
| 41 | Cam plate fastened to wall casing 5 |
| 42 | Cam plate fastened to wall casing 6 |
| 43 | Curved edge of cam plate 41 |
| 44 | Curved edge of cam plate 42 |
| 45 | Rearward wall of slot A |
| 46 | Forward wall of slot A |
| 47 | Rearward wall of slot B |
| 48 | Forward wall of slot B |
| 49 | Rearward wall of slot C |
| 50 | Forward wall of slot C |
| 51 | Beveled corner of cylindrical rim 10 adjacent to rearward wall 45 of |
| | slot A |
| 52 | Beveled corner of cylindrical rim 10 adjacent to rearward wall 47 of |
| | slot B |
| 53 | Beveled corner of cylindrical rim 10 adjacent to rearward wall 49 of |
| | slot C |
| 54 | Rearward face of vane 19 |
| 55 | Forward face of vane 19 |
| 56 | Rearward face of vane 20 |
| 57 | Forward face of vane 20 |
| 58 | Rearward face of vane 21 |
| 59 | Forward face of vane 21 |
| 61 | Typical cut-out corner of inner edge of vanes 19, 20 and 21 in contact |
| | with curve edge 43 of cam plate 41 |
| 62 | Typical cut-out corner of inner edge of vanes 19, 20 and 21 in contact |
| | with curve edge 44 of cam plate 42 |
| 63 | Typical end edge of vanes 19, 20 and 21 in contact with interior face |
| | 37 of end wall casing 5 |
| 64 | Typical end edge of vanes 19, 20 and 21 in contact with interior face |
| | 38 of end wall casing 6 |
| 65 | Set of key slots of hub 16 of rotor 9 and on engine shaft 18 |
| 66 | Set of keys locking hub 16 of rotor 9 with engine shaft 18 |
| 67 | Set of sealing elements with pressure spring 71 along outer edge of |
| | vanes 19, 20 and 21 in contact with inner surface 4 of peripheral |
| | casing 1. |
| 68 | Set of sealing elements with pressure spring 71 along end edge of |
| | vanes 19, 20 and 21 in contact with inner surfaces 37 and 38 of end |
| | walls 5 and 6. |
| 69 | Set of sealing elements with pressure spring 71 along hollow disc-like |
| | end walls 11 and 12 of cylindrical rim of rotor 9 in contact with |
| | interior surfaces 37 and 38 of end walls 5 and 6 of stationary casing. |
| 70 | Set of sealing elements with pressure spring 71 along walls of slots A, |
| | B and C in contact with faces of rectangular vanes 19, 20 and 21. |
| 71 | Corrugated pressure spring of sealing element. |

### DESCRIPTION OF THE PREFERRED EMBODIMENTS

References are made to disclosure Document No. 497348 dated 26 Jul. 2001 on file with the United States Department of Commerce, Patent and Trademark Office (PTO) and to the accompanying drawings shown below in separate sheets.

It should be understood that the accompanying drawings as shown in FIG. 1 to 6 to which references by numbers or letters are made in describing the engine, its part, function, or movement, illustrate only the general configuration of said engine part or movement and do not necessarily provide exact detail or scaled dimensions for fabrication or construction purposes. Also, some elements such as spark plug and bearings, although shown in the drawings as required elements of the apparatus, however, are not claimed as part of the invention, these being standard or commercial part available from outside sources. It should be noted also that in some cases like in peripheral casing 1 and end wall casings 5 and 6 only the interior portions are shown in the drawings, the outer portions which actually form part as covering or projection that accommodate cooling system, lubrication system, bolt holes, and other accessories are integral part of the engine but are not claimed and therefore not shown to simplify and limit the drawings to the basic concept only of the invention.

It should be further noted that vanes 19, 20 and 21 with their respective slots A, B, and C are identical in size, shape, dimension, movement and function.

For a better interpretation of the description, some words are listed herein and given definite meanings to describe the engine and its operation based on rotational position about the axis of the engine shaft.

rotation—in all instances in this case is in clockwise direction.

rotational location or position of part with reference to another part is in clockwise direction unless otherwise specifically described.

description or location of part or parts by numbers even not in numerical sequence is in clockwise direction.

forward—is location or movement of part ahead of another part in clockwise direction

rearward—is location or movement of part behind another part in clockwise direction.

outward—is direction away from the center or longitudinal central axis

inward—is direction toward the center or longitudinal central axis.

outer—is location of part or portion of part far from the central axis or imaginary center plane parallel to end walls

inner—is location of part or portion of part near the central axis or imaginary center plane parallel to end walls

As shown in FIGS. 1 to 6, the preferred rotary internal combustion engine in accordance with the present invention is a revolving power-producing apparatus constituted by stationary enclosure housing a cylindrical rotor containing rectangular sliding drive vanes. The rotor rotates with the engine shaft about a concentric axis producing direct rotational power.

The stationary enclosure consists of a peripheral casing 1 and two parallel end wall casings 5 and 6 (FIG. 1 to 4, and 6).

The peripheral casing I is a cylindrical closed curve partly depressed at two opposite arcs 32 and 36 toward and close (near) to the outer surface 13 of cylindrical rim 10 of rotor 9. The inner surface 4 of peripheral casing 1 at arcs 32 and 36 close (near) to the outer surface 13 of cylindrical rim 10 of rotor 9 is provided with appropriate clearance 24 in between the two surfaces to allow free rotation of rotor 9 and transfer (passage) of fuel mixture from intake chamber 26 to compression/combustion chamber 27 along arc 32. Arc 32 from point 33 to point 34 of depressed portion of peripheral casing 1 encompasses an angular distance of 80 degrees more or less or nearly two-thirds (⅔) of the angular distance between two succeeding vanes, at this instant vanes 19 and 20.

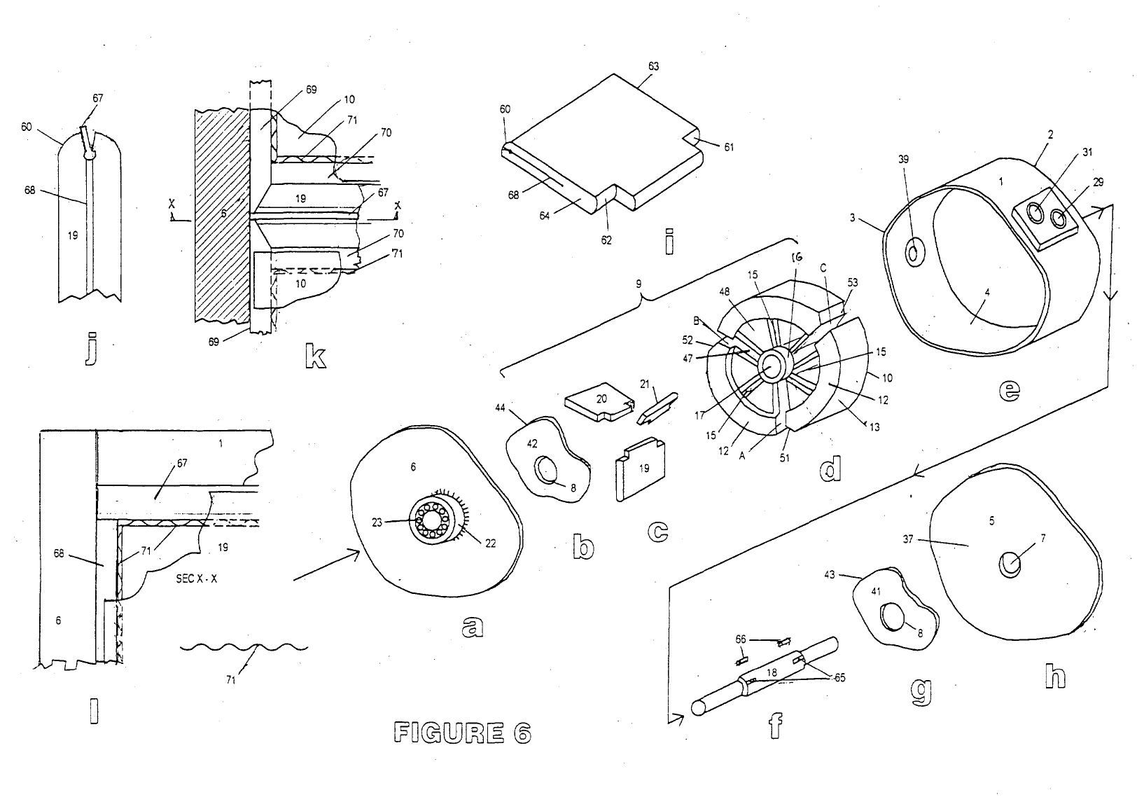

The end wall casings 5 and 6 of stationary enclosure (FIG. 2 and 6) are two parallel plates fastened to ends 2 and 3, respectively, of peripheral casing 1. Each wall casing has a central bore 7 thru which the engine shaft 18 rotates with rotor 9. Each of end wall casing 5 and 6 is provided with corresponding cam plates 41 and 42, respectively, on their inner surfaces which guide and control the radial movement of rectangular sliding drive vanes 19,20 and 21 during rotation of rotor 9. Each of end wall casings 5 and 6 is also provided on their outer surfaces with projected casing 22 which houses the bearing of engine shaft 18. The shape of curved edges 43 and 44 of said cam plates 41 and 42 is the exact reduced radial shape of corresponding contour of inner surface 4 of peripheral casing 1. Each cam plate 41 and 42 is also provided with bore 8 for rotational room of hub 16 of rotor 9.

The space enclosed by the inner surface 4 of one depressed portion of peripheral casing 1 from point 33 to point 35 in cooperation with end wall casings 5 and 6, outer surface 13 of cylindrical rim 10, forward face 55 of vane 19, and rearward face 56 of vane 20 of rotor 9, constitute the compression/combustion chamber 27. It is provided with ignition element 30 that fires to start combustion when fuel mixture attains ideal compression state in this chamber. This compression/combustion chamber becomes part of expansion (power) chamber 28 during burning of the fuel mixture.

The other depressed portion of peripheral casing 1 at arc 36 from end of exhaust port 31 to end of intake port 29 in cooperation with inner surfaces 37 and 38 of end wall casings 5 and 6, respectively, and sealing element 40 constitute the separator 25.The separator 25 (FIG. 1) separates the exhaust chamber 28 from the intake chamber 26. It is provided with sealing element 40 to prevent passage of fuel mixture or burned fuel products between exhaust chamber 28 and intake chamber 26.

One undepressed portion of peripheral casing 1 (FIG. 1, 2 and 3) from end of intake port 29 to point 33 in cooperation with inner surfaces 37 and 38 of end wall casings 5 and 6, respectively, outer surface 13 of cylindrical rim 10, forward face 59 of vane 21, and rearward face 54 of vane 19, at this instant, constitute the intake chamber 26. It is in this chamber that fuel mixture is allowed to enter through the intake port 29. The fuel mixture that occupies the intake chamber 26 is eventually trapped between two succeeding vanes (vanes 21 and 19 at this instant) when vane 21 passes the intake port 29 during clockwise rotation of rotor 9.

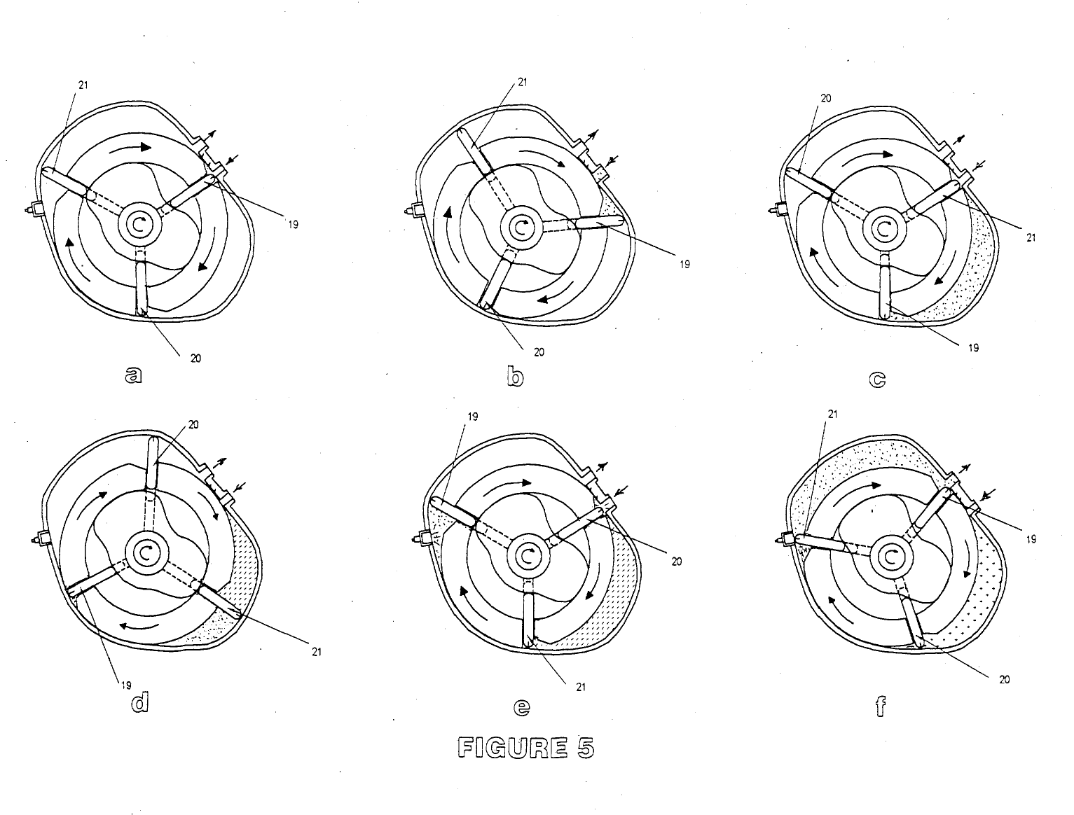

The other undepressed portion of peripheral casing 1 (FIG. 1,2 and 3) from point 34 to a point just before the exhaust port 31 or rearward face of moving vane (rearward face 56 of vane 20 at this instant) in cooperation with inner surfaces 37 and 38 of end wall casings 5 and 6, respectively, and outer surface 13 of cylindrical rim 10, form the expansion (power) chamber 28. It is provided with exhaust port 31 for the discharge of burned fuel products when it is converted into exhaust chamber when the vane moving in this chamber (vane 19 at this instant, in FIG. 5f) reaches and passes the exhaust port 31.

Rotor 9 (FIG. 2,3 and 6) is the revolving piston component of the engine. It consists of a cylindrical rim 10 with three longitudinal radial slots A, B and C located equidistant around said rim of said rotor 9. Slot A is formed by rearward wall 45 and forward wall 46; slot B by rearward wall 47 and forward wall 48; and slot C by rearward wall 49 and forward wall 50. Each radial slot A, B and C contains a corresponding rectangular sliding drive vane 19, 20 and 21, respectively. The cylindrical rim 10 is fastened to rotor hub 16 by means of sets of spokes 14 and 15 and walls of slots 45, 46 47, 48 49 and 50. It has beveled corner 51 connected to rearward wall 45 of slot A; beveled corner 52 connected to rearward wall 47 of slot B; and beveled corner 53 connected to rearward wall 49 of slot C.

Vanes 19, 20 and 21 (FIG. 1, 2, 3,4 and 6) are identical rectangular plates with cut-out corners at their inner edges 61 and 62 each housed in their respective slots A, B and C. The vanes slide rotationally along the inner surface 4 of peripheral casing 1 and inner surfaces 37 and 38 of end walls 5 and 6 as they slide radially in and out of the slots and cause rotation of rotor 9 during expansion of burned fuel mixture at expansion (power) chamber 28 during engine operation. The radial movement of each vane is controlled by the contours of inner surface 4 of peripheral casing 1 and curve edges 43 and 44 of cam plates 41 and 42, respectively, during rotation of rotor 9. Rotor 9 is fastened and keyed to the engine shaft 18 through its bore 17 by means of set of keys 66 and rotates concentrically with said engine shaft 18 through the central bores 7 of stationary wall casings 5 and 6, producing direct rotational power during engine operation.

As mentioned earlier, sealing is one of the major and intriguing problems confronting the design of efficient and competent rotary engine particularly, between stationary parts and moving parts. To overcome this problem and to attain high efficiency of engine performance during operation, reliable and effective sealing system aside from adequate fuel compression is greatly desired. To this end, appropriate sealing means are provided at the following important locations: a) along outer edges 60 of vanes 19, 20, and 21 (FIG. 3 and 6) all in contact with inner surface 4 of peripheral casing 1; b) along end edges 63 and 64 of vanes 19, 20, and 21 (FIG. 6i, 6j, and 6l) in contact with inner surfaces 37 and 38 of wall casings 5 and 6, respectively; c) along rearward wall 45 and forward wall 46 of slot A in contact with rearward face 54 and forward face 55 of vane 19, along rearward wall 47 and forward wall 48 of slot B in contact with rearward face 56 and forward face 57 of vane 20; along rearward wall 49 and forward wall 50 of slot C in contact with rearward face 58 and forward face 59 of vane 21, respectively; d) along the hollow-disc like end walls 11 and 12 of cylindrical rim of rotor 9 in contact with inner faces 37 and 38 of end wall casings 5 and 6, respectively.

In order to maintain smooth and good working condition of the engine, appropriate bearing 23 and lubrications are provided on moving parts particularly those in contact with stationary surfaces. Also cooling system, electrical system and other necessary accessories are incorporated for efficient and proper engine performance.

The present invention is further understood by describing its operation with the aid of the drawings shown in FIG. 5. Vane 19 is considered in this case to describe the engine operation from the start.

Initially, at the start of the engine, vane 19 is just past the intake port 29 (FIG. 5a). At this instant, fuel mixture is allowed to enter through the intake port 29 to fill the intake chamber 26. As rotor 9 starts to rotate (FIG. 5b) caused by external power supplied by engine starter (not claimed in this invention), more fuel mixture is drawn into the intake chamber 26 by suction force of vane 19 which also moves radially out of rotor slot A by sliding its rounded inner cut-out corner edges 61 and 62 (FIG. 6i) along the curve edges 43 and 44 of cam plates 41 and 42, respectively (FIG. 6b and 6g). The outward movement of vane 19 is further effected by its centrifugal force during rotation of rotor 9. Further rotation of rotor 9 (FIG. 5c) brings vane 21 to a point just past the intake port 29 and vane 19 just at point 33, the beginning of compression chamber 27. Vane 19 is also gradually forced to radially slide back inwardly in slot A as its outer edge 60 slide and follow the contour of the inner surface 4 of peripheral casing 1. At this instant, the first batch of fuel mixture is trapped in the intake chamber 26 between forward face 59 of vane 21 and rearward face 54 of vane 19. By further rotation of rotor 9 (FIG. 5d) the trapped fuel mixture is carried or transferred forward by suction force of vane 19 and forward force of vane 21 to the succeeding compression chamber 27 with reduced space, where said fuel mixture is gradually compressed. At a certain pre-determined location of forward vane ( at this instant, vane 19) at the compression chamber 27, when fuel mixture attains ideal elevated pressure ready for burning, the ignition element 39 (FIG. 1) fires, causing combustion of the first batch of fuel mixture (FIG. 5e). The expanding burned fuel creates a powerful pressure pushing vane 19 forward causing rotor 9 to rotate with the engine shaft 18. Simultaneous with compression, expansion, and exhaust of the first batch of fuel mixture are intake, compression, and expansion of succeeding batches of fuel mixtures. The burned fuel mixture of the initial batch is eventually discharged when vane 19 passes the exhaust port 31 (FIG. 5f) as rotor 9 together with the engine shaft 18 continue to rotate with the combustion and expansion of succeeding batches of fuel mixture. The continuous processes of intake, compression, expansion, and exhaust of succeeding batches of fuel mixture are repeated during engine operation, producing direct rotational power of the engine shaft.

1. A rotary internal combustion engine with variable and transferable volume working chambers constituted by a stationary enclosure housing a revolving cylindrical rotor containing rectangular sliding drive vanes, said rotor fastened to an engine shaft and revolving with the engine shaft about a concentric axis through the central bores of walls of the stationary enclosure, producing direct rotational power.

2. The stationary enclosure according to claim 1 consisting of: (a) peripheral close curve casing partly depressed at two opposite arcs toward and close (near) to the outer surface of a cylindrical rim of a rotor, (i) one of said depressed arcs forming in part the compression/combustion chamber, the angular distance of said depressed arc of said compression/combustion chamber close (near) to the outer surface of said cylindrical rim of said rotor encompassing an angular distance of at least 80 degrees more or less or nearly two-thirds (⅔) of the angular distance between two succeeding vanes; (ii) the other opposite depressed arc of peripheral casing forming in part the separator which separates the exhaust chamber from the intake chamber, (iii) one undepressed portion of peripheral casing between the end of the separator and beginning of the compression/combustion chamber, in clockwise direction, encompassing an angular distance of 120 degrees more or less and forming in part the intake chamber, (iv) the other undepressed portion of peripheral casing from the end of compression/combustion chamber to a point just before the exhaust port forming in part the expansion/exhaust chamber; (b) two parallel end wall casings, i) each wall casing provided with a cam plate on its inner face, the (ii) curve shape of each cam plate being exact reduced radial shape of the corresponding contour of the inner surface of peripheral casing, (iii) said wall casings with their respective cam plates having central bores through which the engine shaft rotates with the rotor about a concentric axis.

3. The revolving cylindrical rotor according to claim 1 consisting of: (a) cylindrical rim fastened to a hub by means of spokes, the ends of said cylindrical rim being provided with hollow disc-like end walls to accommodate sealing elements; (b) said rotor having three longitudinal radial slots, each slot formed by a pair of longitudinal parallel walls also connecting the cylindrical rim to the hub; (c) said slots each housing a rectangular sliding drive vane; (d) said pairs of radial slots and their respective vanes located at equal angular distance of 120 degrees around the cylindrical rotor; (e) said vanes radially sliding in and out of the slots during rotation of the rotor the radial movements of said vanes being controlled by means of the curve edges of cam plates and inner surface of peripheral casing during operation of the engine; (f) the cylindrical surface of said rotor having beveled portions at each corner of slot connected to rear wall of each slot; (g) said rotor fastened and keyed to an engine shaft and rotates with the engine shaft about a concentric axis through the central bores of end walls of the stationary casings.

4. The stationary enclosures according to claim 2 being provided at appropriate locations with (a) intake port for entry of fuel mixture into the intake chamber; (b) ignition means for igniting of fuel mixture at compression-combustion chamber; (c) exhaust port for the discharge of burned fuel mixture at expansion/exhaust chamber.

5. The revolving cylindrical rotor according to claim 3 being provided with sealing elements at the following locations: (a) along the outer and end edges of each vane in contact with the inner surfaces of peripheral casings and end wall casings of the stationary enclosure; (b) along the hollow disc-like end walls of cylindrical rim of the rotor in contact with the inner surfaces of end wall casings of stationary enclosure; (c) along the faces of walls of slots in contact with the faces of the vanes; (d) and along the longitudinal inner surface of depressed peripheral casing at the separator in contact with the cylindrical surface of the rotor.

6. The configurations and arrangements of the working chambers and the sealing elements of said rotary engine according to claims 2, 3 and 5 and as shown in the attached drawings.
